(19) United States
(12) Patent Application Publication
(10) Pub. No.: US 2003/0000255 A1
(43) Pub. Date: Jan. 2, 2003

(54) Method of producing optical fiber preform and sintering apparatus

(75) Inventors: Yukio Kohmura, Kanagawa (JP); Hiroyuki Wada, Mie (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: The Furukawa Electric Co., Ltd., Tokyo (JP)

(21) Appl. No.: 10/180,070

(22) Filed: Jun. 27, 2002

(30) Foreign Application Priority Data
Jun. 28, 2001 (JP) 2001-197082

(51) Int. Cl. C03B 37/07

(52) U.S. Cl. 65/384; 65/486; 65/488

(57) ABSTRACT

A method and apparatus for sintering a large-sized optical fiber preform without the occurrence of a large difference of diameters in a longitudinal direction, a non-solidified portion in a solidified portion of a porous soot body and a drop of the optical fiber preform. In response to a relative position of a sintering position of a porous soot body in an optical fiber preform to a sintering zone, in other words, in response to either of a lower end, an intermediate portion or an upper end of the optical fiber preform in the sintering zone, a controller controls at least one of a sintering temperature of an electric heater, a moving speed of the optical fiber preform and a supply gas flow supplying to the sintering zone.

### BACKGROUND OF THE INVENTION

1. Field of the Invention

The present invention relates to an optical fiber and an apparatus thereof.

More particularly, the present invention relates to a method of sintering a silica-based glass porous body (silica-based glass soot body) of an optical fiber preform used for forming an optical fiber, and a sintering apparatus.

2. Description of the Related Art

A variety types of optical fibers are known and used, but, a silica-based glass single mode optical fiber (SMF) will be described as an example. The SMF includes a core having a diameter of 10 μm and a cladding layer formed on the core and having a diameter of 125 μm. A refractive index of the core is higher than that of the cladding layer. An example of a method of producing the SMF will be briefly described with reference to FIG. 1.

Steps 1 to 3: Formations of Glass Rod of Core Portion

Step 1: A silica-based glass porous soot body is synthesized on a seed rod by, for example, a vapor-phase axial deposition (VAD) method or an outside vapor-phase deposition (OVD) method. The porous soot body will be formed as the core of the SMF. In the step (process), a dopant for increasing the refractive index of the core, for example, Ge will be doped, if necessary.

Step 2: The synthesized porous soot body is introduced into a sintering furnace, and dehydrated and sintered (solidified or vitrified) therein to form a transparent glass preform for the core.

Step 3: The resultant transparent glass core preform is elongated to form an elongated glass rod for the core. Such the elongation can be performed in a heating condition by using a flame of combustion, plasma flame or an electric furnace.

Step 4 to 5: Formation of Cladding Portion

Step 4: A porous soot body is synthesized on a periphery of the elongated glass core rod by, for example, the OVD method. The synthesized porous soot body will be formed as the cladding layer of the SMF.

Step 5: The resultant optical fiber soot preform comprising the elongated glass core rod and the porous soot cladding body synthesized on the glass core rod, is introduced into the sintering furnace, and dehydrated and sintered the porous soot cladding body. As a result, an optical fiber preform comprising the elongated glass core rod and the glass cladding portion is formed.

Steps 6 to 7: Formation of Optical Fiber

Step 6: The resultant optical fiber preform is introduced into a drawing furnace, heated therein to melt and drawn out the melt preform from the drawing furnace to result in the SMF comprising the core having a diameter of 10 μm and the cladding layer formed on the periphery of the core and having a diameter of 125 μm.

Step 7: A protective resin is coated on the periphery of the cladding layer to produce the final product of the SMF.

Alternatively, for producing the transparent core glass rod in steps 1 to 2, such the transparent core glass rod can be directly produced by a modified CVD method or a plasm method. In this method, the dehydrating and sintering processes are not necessary. The processes thereafter can be applied as same as the above processes.

To improve the productivity of the optical fiber, for example, the optical fiber preform used for producing the optical fiber becomes large in size. For example, the optical fiber preform having a length of 2,400 mm or more, a diameter 250 mm or more and a weight 40 kg or more may be produced.

Inventors of the present patent application found disadvantages in the process of step 5 which will be occurred when producing a large sized optical fiber perform, but were not be occurred when producing a small-sized optical fiber preform. Such the disadvantages will be described with reference to FIGS. 2A and 2B.

As shown in FIG. 2A, a non-sintered portion US may be remained in the cladding porous soot body SN formed on the periphery of the sintered glass core rod CT.

As shown in FIG. 2B, a diameter of the sintered upper portion Y may be smaller than that of the sintered lower portion X. Such a difference of the diameters of the upper portion Y and the lower portion X is larger than a predetermined value, for example, 10 mm, then the optical fiber having desired characteristics can not be obtained.

Also, the sintered optical fiber may be fallen away from the supporting rod SR.

The optical fiber preform used for the single mode optical fiber (SMF) was discussed, but such the disadvantages may be occurred in other optical fiber preforms used for other types of optical fibers, having a porous soot body to be sintered.

### SUMMARY OF THE INVENTION

An object of the present invention is to provide a method of sintering an optical fiber preform which is used for producing an optical fiber, and has desired characteristics.

Another object of the present invention is to provide a sintering apparatus used for the above sintering method.

The inventors of the present patent application investigated reasons of the occurrence of the above disadvantages and found those reasons described below.

It is considered that the occurrence of the disadvantage that the non-sintered portion US is remained in the porous soot body SN to be sintered, described with reference to FIG. 2B, is based on the reason that the sintering starts from a surface of the porous soot body SN, since an electric heater for sintering the porous soot body SN is arranged at an outside of a furnace tube and the porous soot body SN is heated by heat radiated by the furnace tube. Further, it is considered that the occurrence of the disadvantage is based on the reason that He gas, Cl₂ gas and/or impurity are taken in the inner portion of the porous soot body at which the surface is sintered (solidified). Namely, it is considered that such the gases taken in the inner portion disturb the sintering of the inner portion of the porous soot body SN, and the non-sintered portion UN is remained.

It is considered that the occurrence of the disadvantage of the occurrence of the difference in the longitudinal direction of the optical fiber preform, described with reference to FIG. 2B, is based on the reason that the sintering upper portion Y is melting and the tensile strength thereof falls, then the sintering upper portion Y is stretched by the weight of the sintered lower portion.

It is also considered that the occurrence of the disadvantage that the optical fiber preform is fallen away from the support rod SR, is based on the reason that the support rod SR having a small diameter such as 30 mm is melt or soften during sintering the upper portion Y or the upper end of the optical fiber preform, and the melting or soften support rod SR can not support the optical fiber preform.

It is noticed that the above disadvantages are occurred when the optical fiber preform becomes large in size.

The inventors of the present patent application had attempted a variety of experiments under the above knowledges, for overcoming the above disadvantages, and found the key technology: in response to a position of an optical fiber preform to be sintered, (a) changing sintering temperature, (b) changing a relative moving sped between the optical fiber preform and a sintering zone in a sintering furnace, and (c) changing a quantity of gas (gases) for supplying the optical fiber preform to the sintering zone.

According to a first aspect of the present invention, there is provided a method of producing an optical fiber preform including the step of dehydrating and sintering a porous soot body of the optical fiber preform in a state where the optical fiber preform is suspended, the sintering being carried out by varying at least one of a sintering temperature of the porous soot body, a relative moving speed between a sintering position of the porous soot body and a sintering zone, and a flow of gas supplied to the sintering zone, in response to a position of the optical fiber preform positioned to the sintering zone.

The dehydrating process and the sintering process can be simultaneously performed in a same sintering apparatus or independently.

The sintering temperature of the porous soot body may be controlled in response to the position of the optical fiber preform positioned to the sintering zone under the following condition, when a predetermined flow of the gas is supplied to the sintering zone and at a predetermined relative speed between the optical fiber preform and the sintering zone,

T₁>T₂≧T₃

where,

T₁ is a sintering temperature of the porous soot body at a lower end of the optical fiber preform,

T₃ is a sintering temperature of the porous soot body at an upper end of the optical fiber preform, and

T₂ is a sintering temperature of the porous soot body at an intermediate portion between the lower and upper ends, and is changed monotonously from the temperature T₁ to the temperature T₃.

The relative moving speed between the sintering zone and the optical fiber preform may be controlled in response to the position of the optical fiber preform positioned to the sintering zone under the following condition, when a predetermined flow of the gas is supplied to the sintering zone, at a predetermined sintering temperature,

S₁<S₂≦S₃

where,

S₁ is the relative moving speed when sintering the porous soot body at a lower end of the optical fiber preform,

S₃ is the relative speed when sintering the porous soot body at an upper end of the optical fiber preform, and

S₂ is the relative speed when sintering the porous soot body at an intermediate portion between the lower and upper ends, and is changed monotonously from the speed S₁ to the speed S₃.

The flow of the gas supplied to the sintering zone may be controlled in response to the position of the optical fiber preform positioned to the sintering zone under the following condition, at a predetermined relative speed between the optical fiber preform and the sintering zone,

V₁>V₂≧V₃

where,

V₁ is the flow of the gas when sintering the porous soot body at a lower end of the optical fiber preform,

V₃ is the flow of the gas when sintering the porous soot body at an upper end of the optical fiber preform, and

V₂ is the flow of the gas when sintering the porous soot body at an intermediate portion between the lower and upper ends, and is between the flow V₁ and the flow V₃.

Such the controls can be combined.

According to a second aspect of the present invention there is provided an apparatus for dehydrating, and/or sintering a porous soot body of an optical fiber preform, comprising: a furnace tube into which the optical fiber preform is introduced; a supporting means for holding an end the optical fiber preform, being rotatable the optical fiber preform and introducing the optical fiber preform into the furnace tube; a heating means for heating the optical fiber preform introduced into the furnace tube; a position sensing means for detecting a relative position between a sintering position of the porous soot body and a sintering zone in the furnace tube; a speed sensing means for detecting a relative moving speed between the sintering zone in the furnace tube and the optical fiber preform; a gas supplying means for supplying a sintering gas to the sintering zone in the furnace tube; a temperature sensing means for detecting a sintering temperature at the sintering zone in the furnace tube; and a control means, the control means controlling the sintering by varying at least one of a sintering temperature of the porous soot body, a relative moving speed between a sintering position of the porous soot body and a sintering zone, and a flow of gas supplied to the sintering zone, in response to a position of the optical fiber preform positioned at the sintering zone.

### BRIEF DESCRIPTION OF THE DRAWINGS

The above and other objects and features of the present invention will be apparent more in detail with reference to the accompanying drawings, in which:

FIG. 1 is a process flow chart showing processes for producing a single mode optical fiber;

FIGS. 2A and 2B are views showing shapes of defective solidified optical fiber preforms;

FIG. 3A is a sectional view of an optical fiber preform wherein a porous soot body of a cladding portion is synthesized on the periphery of a core portion, along a longitudinal direction, and FIG. 3B is a cross sectional view of the optical fiber preform shown in FIG. 3A;

FIG. 4A is a view showing a state where the optical fiber preforms shown in FIG. 3A is suspended for sintering, and FIG. 4B is a view showing a shape of a solidified transparent optical fiber preform;

FIG. 5 is a view showing a configuration of a sintering apparatus of a present embodiment;

FIG. 6 is a graph showing a characteristic of a sintering position of an optical fiber preform and a sintering temperature;

FIG. 7 is a graph showing a characteristic of a sintering position and a moving speed of an optical fiber preform to a sintering zone;

FIG. 8 is a graph showing a characteristic of a sintering position of an optical fiber preform and a supply gas flow; and

FIG. 9 is a process flow chart showing a dehydrating process and a sintering process shown in step 5 in FIG. 5.

### DESCRIPTION OF THE PREFERRED EMBODIMENTS

A method of sintering a porous soot body of an optical fiber preform and a sintering apparatus of the preferred embodiments according to the present invention will be described.

As a preferred embodiment, a method of sintering a porous soot body of a cladding portion in an optical fiber preform for a silica-based glass single mode optical fiber (SMF).

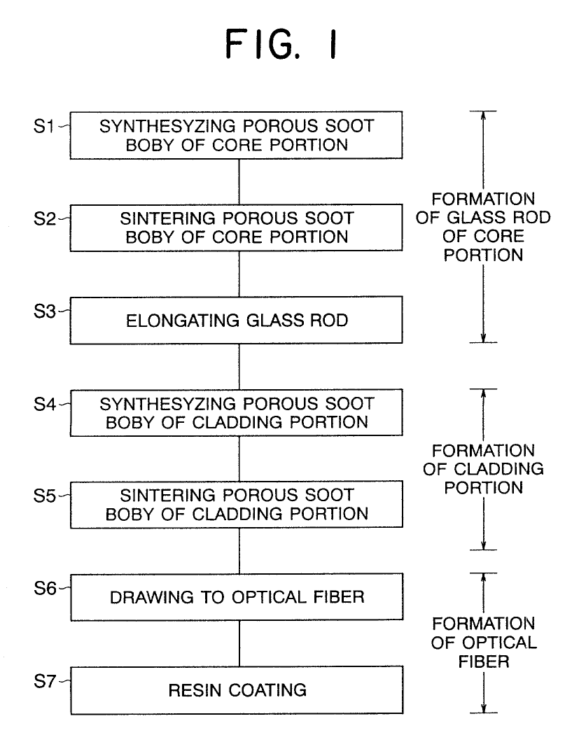

The method of sintering a porous soot body of an optical fiber preform concerns to the process of step 5 of FIG. 1. Accordingly, prior to the carrying out of the present embodiment, the processes of steps 1 to 4 of FIG. 1 are previously performed to result in the formation of an optical fiber preform 50 shown in FIGS. 3A and 3B.

Optical Fiber Preform

The optical fiber preform 50 includes a core portion 52 which was synthesized as a porous soot body for a core portion at step 1, sintered to a transparent glass at step 2, and elongated at step 3, and a support rod 54 connected to a tip pf the core portion 52. The core portion 52 and the support rod 54 are called as a transparent glass rod 60.

The optical fiber preform 50 further includes a porous soot body 58 of a cladding portion which was synthesized on the peripheral of the core portion 52 at step 4. The porous soot body 58 of the cladding portion will be sintered at step 5.

The optical fiber preform 50 is comprised of an end 72, an intermediate portion 70 and another end 74, arranged in a longitudinal direction, and formed as a unit. The intermediate portion 70 has a cylindrical shape and is formed by the core portion 52 and the porous soot body 58 of the cladding portion in which a ratio of diameters O₅₂ and O₅₈ thereof is in a predetermined range d₁ and d₂. Shapes of the ends 72 and 74 are rounded or projected and a ratio of the diameters D₅₂ and D₅₈ of the core portion 52 and the porous soot body 58 is not in a predetermined range d₁ and d₂.

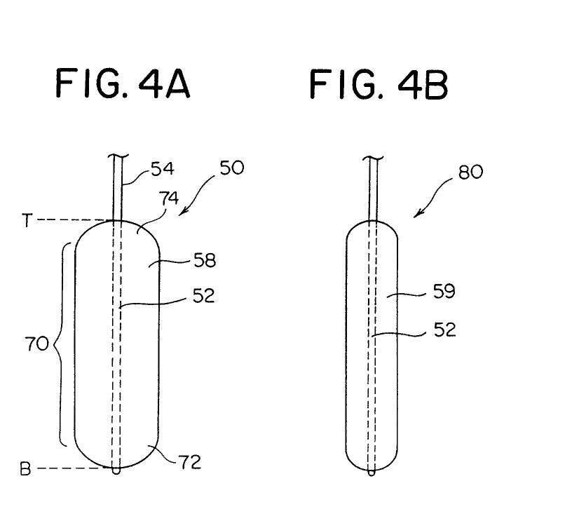

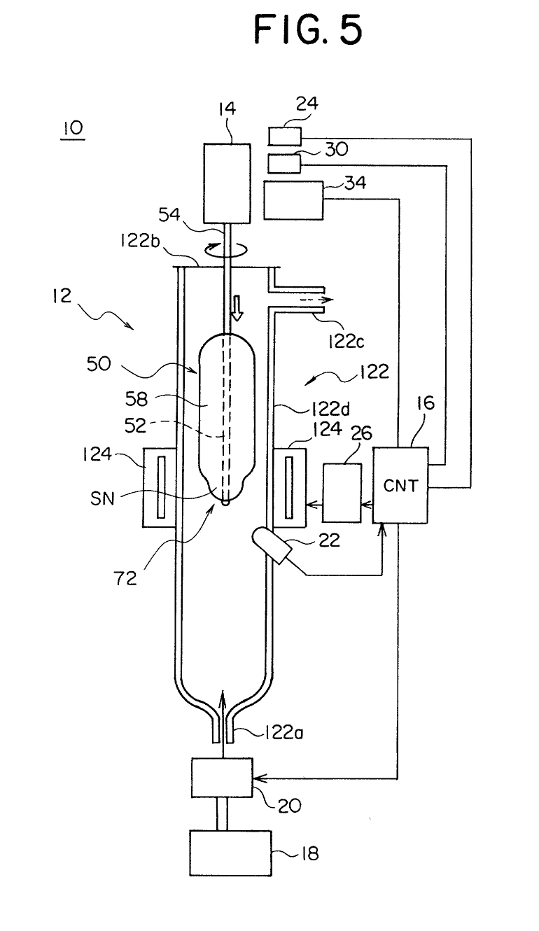

Referring to FIGS. 4A and 4D, and FIG. 5, the support rod 54 connected to the end 74 of the optical fiber preform 50 is held by a supporting mechanism 14 and the optical fiber preform 50 is suspended and introduced into a sintering furnace 12. In this embodiment, the end 72 is called as a lower end, and the end 74 is called as an upper end.

The optical fiber preform 50 in which the porous soot body 58 of the cladding portion was synthesized on the transparent glass core portion 52 in step 5 is introduced into the sintering furnace and the porous soot body 58 is dehydrated and sintered to form a transparent glass, and to thereby produce a solidified optical fiber preform 80 shown in FIG. 4B. The solidified optical fiber preform 80 has a transparent solidified glass portion 59 which is transparent and has a small diameter than the diameter of the porous soot body 58 of the optical fiber preform 50.

The solidified optical fiber preform 80 is processed in steps 6 and 7 of FIG. 1 to form a silica-based glass single mode optical fiber as a final product.

The processing of step 5 of the present embodiment and a sintering apparatus therefore will be described in detail.

First Embodiment

FIG. 5 is a view for illustrating a configuration of a sintering apparatus for sintering a porous soot body of an optical preform, as a first embodiment.

A sintering apparatus shown in FIG. 5 has a sintering furnace 12, a supporting mechanism 14, a controller 16, a gas supply portion 18, a gas flow meter 20, a temperature sensor 22, a speed sensor 24, an electric heater drive portion 26, a position sensor 30 and a supporting mechanism drive portion 34.

The sintering apparatus 10 performs the dehydration and sintering, simultaneously.

The sintering furnace 12 includes a hollow and cylindrical shaped furnace tube 122.

The furnace tube 122 is formed by, for example, silica-based glass, and has a gas supply inlet 122a positioned at a bottom, an upper introduction portion 122b positioned at a top, a gas exhaust portion. 122c, positioned adjacent to the upper introduction portion 122b, and an intermediate cylindrical portion 122d positioned between the upper introduction portion 122b and the gas supply inlet 122a.

The optical fiber preform 50 to be sintered is introduced into the inside of the furnace tube 122 through the upper introduction portion 122b, by the supporting mechanism 14.

Sintering gas is supplied from the gas supply portion 18, passed through the gas flow meter 20, introduced into the furnace tube 122 through the gas supply inlet 122a, risen in the furnace tube 122, and exhausted from the gas exhaust portion 122c.

The sintering furnace 12 has a concentric shaped electric heater 124 arranged around the outer circumference of the intermediate cylindrical portion 122d of the furnace tube 122.

A heat equalizing tube (not shown) is provided in a gap between the inside of the electric heater 124 and the outer circumference of the intermediate cylindrical portion 122d, and made of, for example, a carbon. The heat equalizing tube equalizes heat radiated from the electric heater 124 and transfer the equalized heat to a portion to be sintered (a sintering zone) of the optical fiber preform 50 in the furnace tube 122. Namely, heat from the electric heater 124 is equalized by the heat equalizing tube and the equalized heat dehydrates the porous soot body 58 of the cladding portion of the optical fiber preform 50 and sinters the dehydrated cladding portion to form a transparent glass.

The electric heater 124 is supplied with electric power from the electric heater drive portion 26. The electric power supplied from the electric heater drive portion 26 to the electric heater 124 is controlled by the controller 16.

The electric heater 124 and the heat equalizing tube correspond to a heating means of the present invention, and defines the sintering zone in the furnace tube 122.

The supporting mechanism 14 holds the support rod 54 connected to the upper end 74 of the optical fiber preform 50 to suspend the optical fiber perform 50 in a vertical direction, and introduces the optical fiber preform 50 into the furnace tube 122 through the upper introduction portion 122b.

The supporting mechanism 14 rotates the optical fiber preform 50 and descends the same in the furnace tube 122 in response to the progress of the sintering of the porous soot body 58. The supporting mechanism drive portion 34 performs the descent and rotation operation of the supporting mechanism 14 in response to a command from the controller 16.

The controller 16 controls the descent operation of the supporting mechanism 14 through the supporting mechanism drive portion 34 and descends the optical fiber preform 50 so that the portion to be sintered of the porous soot body of the optical fiber preform 50 is positioned at the sintering zone positioned of the electric heater 124.

The controller 16 is constructed by, for example, a computer having a memory, and performs a variety of controls described in the specification.

The speed sensor 24 and the position sensor 30 are provided in the supporting mechanism 14, for example.

The position sensor 30 detects a relative position of the portion to be sintered of the porous soot body 58 of the optical fiber preform 50 to the sintering position positioned at the electric heater 122, and inputs the detected relative position to the controller 16. The relative position is varied in response to the descent operation of the supporting mechanism 14. The position sensor 30, for example, accumulates a rotation of a motor for descending the optical fiber preform 50 and installed in the supporting mechanism 14 and detects the position of the optical fiber preform 50 to the sintering position positioned at the electric heater 124.

The speed sensor 24 detects the descent speed of the optical fiber preform 50 and inputs the detected speed to the controller 16. The speed sensor 24, for example, detects a rotation speed of the descent motor as the descent speed of the optical fiber preform 50.

In the present embodiment, it is described that the electric heater 124 is fixed at the around the furnace tube 122, and the optical fiber preform 50 descents into the furnace tube 122, conversely, the position of the optical fiber preform 50 can be fixed and the electric heater 124 can be moved upward. Then, the speed sensor 24 detects a moving speed of the electric heater 124 to the optical fiber preform 50, and the position sensor 30 detects a moving position of the electric heater 124 to the optical fiber preform 50.

The temperature sensor 22 detects a temperature at the sintering portion of the porous soot body 58 of the optical fiber preform 50 positioned in the intermediate cylindrical portion 122d of the furnace tube 122. The temperature sensor 22 is provided at a wall of the furnace tube 122. The temperature sensor 22, for example, is a radiation-type temperature sensor.

The temperature signal detected by the temperature sensor 22 is input to the controller 16.

The gas supply portion 18 supplies the gas to the inside of the furnace tube 122 through the gas flow meter 20 and the gas supply inlet 122a. The gas supplied through the gas supply inlet 122a raises the inside of the intermediate cylindrical portion 122d, contacts to the optical fiber preform 50 and exhausts from the gas exhaust portion 122c. A portion around the sintering position of the porous soot body 58 of the optical fiber preform 50 in the furnace tube 122, and positioned adjacent to the electric heater 124, is called as the sintering zone or a sintering atmosphere.

The controller 16 controls the gas flow meter 20 and controls the flow of the gas supplied into the furnace tube 122.

The gas may be inert gas such as He gas, As gas or N₂ gas, and/or, Cl₂ gas.

In the above description, the dopant for raising the refractive index of the core portion, for example, Ge was doped. Alternatively, such the dopant is not doped to the core portion, and a dopant decreasing the refractive index of the cladding portion can be doped to the cladding portion in the sintering process. In this case, the dopant decreasing the refractive index of the cladding portion, such as F, can be included in the gas supplied from the gas supply portion 18.

FIG. 5 shows a state where the gas supply portion 18 supplies the gas into the furnace tube 122, and the supporting mechanism 14 hold the support rod 14 connected to the optical fiber preform 50 to suspend the optical fiber preform 50 in the furnace tube 122, rotates the optical fiber preform 50 and descends the optical fiber preform in the furnace tube 122 at a predetermined speed in response to the progress of the sintering of the porous soot body 58. Namely, FIG. 5 shows a state where the porous soot body 58 of the optical fiber preform 50 is heated by heat from the electric heater 124 to dehydrate and sinter, from the lower end 72, via the intermediate portion 70, to the upper 74 end, to thereby solidify the porous soot body 58 as a transparent glass. Especially, FIG. 5 shows a state where the porous soot body 58 at the lower end 72 of the optical fiber preform 50 is formed as a transparent solidified (vitrified) portion SN. When all the porous soot body 58 is sintered, the transparent sintered portion 59 is obtained, and the optical fiber preform 80 shown in FIG. 4B having a smaller diameter than that of the optical fiber preform 50 is formed.

The control by the controller 16 will be described.

Sintering Temperature Control

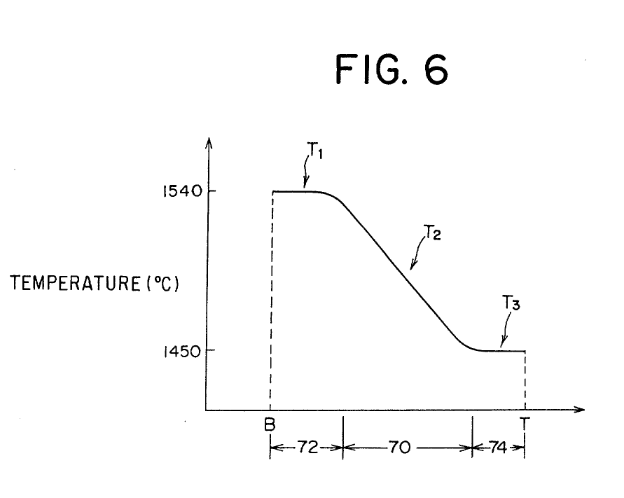

FIG. 6 is a graph showing a characteristic between a position and a sintering temperature, where an abscissa indicates the sintering position of the porous soot body 58 of the optical fiber preform 50 and an ordinate indicates the sintering temperature.

In this case, the descent speed of the optical fiber preform 50 into the furnace tube 122 is constant, and the flow of the gas, for example, He, supplied from the gas supply portion 18 and introduced into the furnace tube 122 is also constant.

The relationship among the sintering temperatures T₁, T₂ and T₃ illustrated in FIG. 6 is defined by the following formula:

T₁>T₂≧T₃ (1)

The characteristic between the position and the sintering temperature means that when sintering the porous soot body 58 at the lower end 72 of the optical fiber preform 50, the sintering temperature T₁ is set at a high temperature, for example, 1540° C., when sintering the porous soot body 58 at the upper end 74, the sintering temperature T₃ is set at a low temperature, for example, 1450° C., and when sintering the porous soot body 58 at the intermediate portion 70, the sintering temperature is monotonously varied from the high temperature T₁ to the low temperature T₃ in response to the position of the intermediate portion 70 in the sintering zone positioned at the electric heater 124.

When the sintering temperature for sintering the porous soot body 58 at the lower end 72 is high, the sintered glass body becomes soft and has straight shape due to the gravity. Conversely, when the sintering temperature at the lower end 72 is low, the sintered glass body may be bent in a horizontal direction. When the sintered glass body at the lower end 72 is formed straight, the intermediate portion 70 and the upper 74 may be sintered straight to form the solidified optical fiber preform 80 having a true circular shape in a cross section. If the lower sintered end 72 is not formed straight, the optical fiber preform 80 cannot have a true circular shape in a cross section. As discussed above, the sintering temperature T₁ at the lower end 72 should be high.

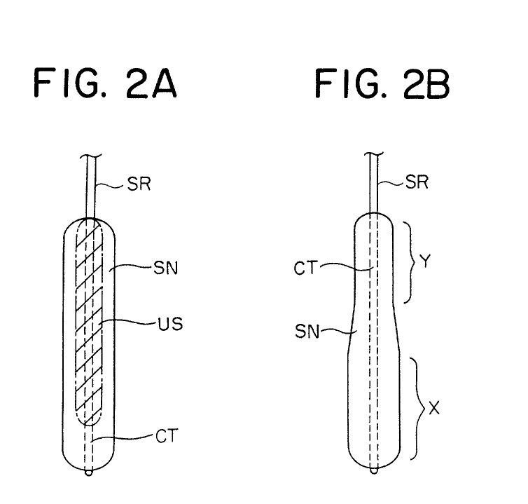

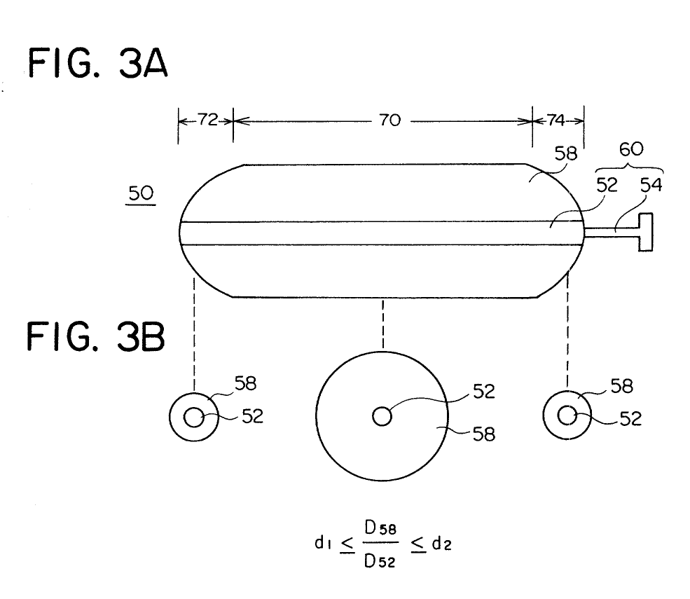

By sintering the porous soot body 58 at the upper end 74 at a low temperature, the disadvantage where the support rod 54 is melted or soften and the optical fiber preform 50 may drop away from the support rod 54, described with reference to FIG. 2B, is overcome.

The sintering temperature at the intermediate portion 70 is monotonously varied from the temperature T₁ to the temperature T₃, but, if such the sintering temperature is abruptly varied, the sintering process becomes unstable, and the sintered glass portion may crack. Therefore, an abrupt change of the sintering temperature is not preferred. The change rate of the sintering temperature T₂ of the porous soot body 58 at the intermediate portion 70, of course, depends upon the descent speed of the optical fiber preform 50 and other conditions, but is preferably approximately 0.1 to 0.25° C./min.

Of course, the temperature T₁ and the temperature T₃ depend upon the descent speed of the optical fiber preform 50, the grade and flow of the gas (gases) supplied from the gas supply portion 18, a size (diameter, length and weight) of the optical fiber preform 50 and other conditions, but, the sintering of the porous soot body 58 of the optical fiber preform 50 should be done under the temperature relationship defined by the formula 1.

The controller 16 reads the position signal detected by the position sensor 30 and the temperature signal detected by the temperature sensor 22, and controls the temperature of the electric neater 124 through the electric heater drive portion 26 under the formula 1, in response to the detected position signal and the detected temperature signal, to thereby achieve the preferable sintering temperature control for the porous soot body 58 of the optical fiber preform 50.

The temperatures T₁ and T₃ and the change rate of the temperature T₂ are stored in the memory of the controller 16.

### EXAMPLE 1

The sintering temperature control was attempted for the porous soot body 58 of the optical fiber preform having a length of 2400, a diameter of 250 mm and a weight of 40 Kg. The time for sintering was 8 to 10 hours. The sintered optical fiber preform 80 has a diameter of 20 to 80 mm, having a cylindrical shape in a longitudinal direction and a cross section of which is approximately true circle, and thus having less diameter difference in the longitudinal direction. There is not found the non-sintered portion as shown in FIG. 2A. Of course, the drop of the optical fiber preform 50 away from the support rod 54 was not occurred.

The resultant optical fiber preform 80 was processed by the processes of steps 6 and 7. The resultant single mode optical fiber shows the non-circularity of less 0.3%.

Sintering Moving Speed Control

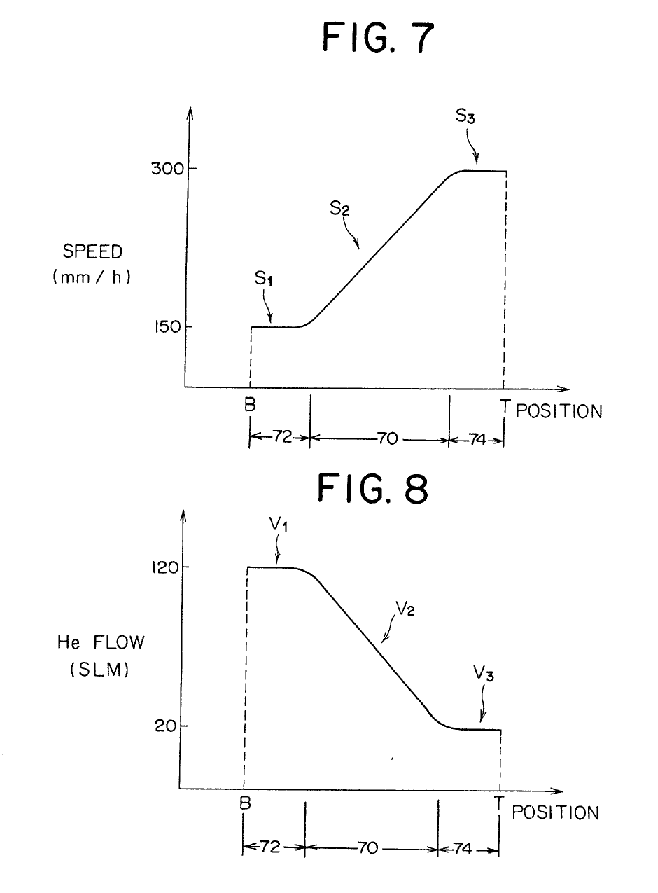

FIG. 7 is a graph showing a characteristic between a position and a moving speed of the optical fiber preform 50, where an abscissa indicates the position and an ordinate indicates the moving speed.

In this case, the heat temperature of the electric heater 124 is constant, and the flow of the gas, for example, He, supplied from the gas supply portion 18 and introduced into the furnace tube 122 is constant.

The relationship of the moving (descent) speeds S₁, S₂ and S₃ is defined by the following formula 2.

S₁<S₂≦S₃ (2)

The position moving speed characteristic shown in FIG. 7 means that when sintering the porous soot body 58 at the lower end 72 of the optical fiber preform 50, the descent (moving) speed S₁ is set low, such as 150 mm/h, to dwell the lower end 72 in the sintering zone inside of the electric heater 124 for a long time, when sintering the upper end 74, the descent speed S₃ is set high, such as 300 mm/h, to pass the upper end 74 through the sintering zone for a short time, and when sintering the intermediate portion 70, the descent speed S₂ is monotonously varied from the low speed S₁ to the high speed S₃ in response to the position of the intermediate portion 70 in the sintering zone.

Such the moving speed control overcomes the disadvantages described with reference to FIGS. 2A and 2B, as similar to the above sintering temperature control.

The values of the moving speeds S₁ and S₃ and the change rate of the moving speed S₂ depend upon the size (length, diameter and weight) of the optical fiber preform 50, the sintering temperature, the grade and flow of the gas supplied from the gas supply portion 18 and other conditions, but, the sintering of the porous soot body 58 of the optical fiber preform 50 should be carried out under the moving speed relationship defined by the formula 2.

The controller 18 reads the position signal detected by the position sensor 30 and the speed signal detected by the speed sensor 24, and controls the descent speed of the optical fiber preform 50 through the supporting mechanism drive portion 34, under the relationship defined by the formula 2, in response to the position signal and the speed signal.

The values of the moving (descent) speeds S₁ and S₃ and the change rate of the moving speed S₂ are stored in the memory of the controller 16.

### EXAMPLE 2

The moving speed control was attempted and obtained the results similar to those of the above sintering temperature control.

Supply Gas Flow Control

FIG. 8 is a graph showing the position of the optical fiber preform 50 to the sintering zone and the flow of the gas, for example, H₂, where an abscissa indicates the position and an ordinate indicates the gas flow.

In this case, the moving speed of the optical fiber preform 50 by the supporting mechanism 14 to the sintering zone is constant.

The relationship of the supply gas flows V₁, V₂ and V₃ shown in FIG. 8 is defined by the following formula 3.

V₁>V₂≧V₃ (3)

The characteristic between the position and the supply gas flow shown in FIG. 8 means that when sintering the porous soot body 58 at the lower end 72 of the optical fiber preform 50, a large gas flow V₁, for example, 120 SLM is supplied, when sintering the upper end 74 a small gas flow V₃, for example, 20 SLM is supplied, and when sintering the intermediate portion 70 a gas flow V₂ between the large gas flow V₁ and the small gas flow V₃ is supplied.

Since the lower end 72 is sintered at a high temperature as mentioned above, the surface of the porous soot body 58 thereat is facilitated to a solidified state, then a large gas flow is supplied to cool and retard the solidification thereat.

Since the upper end 74 is sintered at the low temperature as described above, the surface of the porous soot body 58 is not easily solidified, then the gas flow is reduced. By reducing the supply gas flow when sintering the porous soot body 58 at the upper end 74, the residual gas such as He or Cl₂ and the residual impurities in the inside of the solidified cladding portion 59 are very small or less, then the occurrence of the non-solidified portion US shown in FIG. 2B can be prevented. In addition, since the supply of expensive gas such as He can be reduced, the cost of the single mode optical fiber as the final product can be reduced.

The values of the gas flows V₁, V₂ and V₃ depend upon the grade of the supply gas (gases), the moving speed of the optical fiber preform 50, the sintering temperature, the size (length, diameter and weight) of the optical fiber preform 50 and other conditions, but it is preferable to carry out the sintering the optical fiber preform 50 under the supply gas flow condition defined by the formula 3.

The controller 16 reads the position signal detected by the position sensor 30 and controls the gas flow meter 20 to thereby control the flow of the gas supplied from the gas supply portion 18 to the inside of the furnace tube 12.

The values of the gas flows V₁, V₂ and V₃ are stored in the memory of the controller 16.

### EXAMPLE 3

The gas flow control was attempted, and there was not appeared the non-solidified portion US as shown in FIG. 2A.

In the present embodiment, the above sintering temperature control, the moving speed control and the supply gas flow control can be performed independently or in a suitable combination of them.

Combination of Supply Gas Flow Control and Sintering Temperature Control

When the supply gas flow control and the sintering temperature control are combined and the combined control is performed, the occurrence of the non-solidified portion US shown in FIG. 2B in the solidified cladding portion 59 shown in FIG. 4B can be prevented and the effects of the sintering temperature control can be obtained.

Combination of Supply Gas Flow Control and Moving Speed Control

When the supply gas flow control and the moving speed control are combined and the combined control is performed, the occurrence of the non-solidified portion US in the solidified cladding portion 59 can be prevented and the effects of the moving speed control can be obtained.

Combination of Sintering Temperature Control and Moving Speed Control

When the sintering temperature control and the moving speed control are combined, the porous soot body 58 at the lower end 72 of the optical fiber preform 50 can be sintered at a high temperature for a long time, and the porous soot body at the upper end 74 can be sintered at a low temperature for a short time. As a result, the disadvantages described above can be overcome.

Combination Supply Gas Flow Control, Sintering Temperature Controls and Moving Speed Control

When combining the supply gas flow control, the sintering temperature control and the moving speed control, all the effects described above can be obtained.

According to the first embodiment, the sintering of the large-sized optical fiber preform 50 having a length over 1000 mm, a diameter over 200 mm, and a heavy weight can be achieved without large diameter differences in a longitudinal direction and a uniform solidification can be realized. As a result, the resultant single mode optical fiber has the non-circularity less than 0.3%.

According to the first embodiment, there is not dropped the optical fiber preform 50 away from the support rod 54 during sintering.

According to the first embodiment, the supply (consumption) of the expensive gas such as He supplied from the gas supply portion 18 can be reduced. As a result, the cost of the solidified optical fiber preform 80 can be reduced, and therefore, the cost of the single mode optical fiber as the final product can be reduced.

Second Embodiment

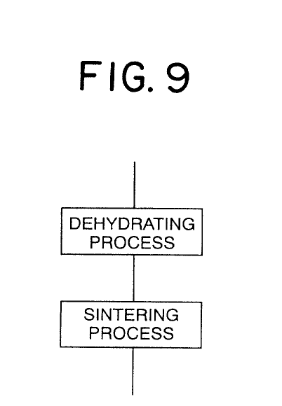

In the first embodiment, the dehydrating process and the sintering process are performed as one step in the sintering furnace 12, but, in a second embodiment, as shown in FIG. 9, such the dehydrating process and the sintering process are performed in different two steps.

First, the dehydrating process is performed at a constant temperature, for example, 1150-1200° C.

After that, the sintering process is performed for the dehydrating optical fiber preform by using the sintering apparatus 10 in a similar process of the first embodiment. Of course, one of or any combination of the sintering temperature control, the moving speed control and the supply gas flow control can be carried out.

According to the second embodiment, the effects same as in the first embodiment can be obtained.

In addition, according to the second embodiment, by separating the dehydrating process and the sintering process, water, moisture and humidity contained in the porous soot body 58 of the optical fiber preform 50 are greatly reduced in a sufficiently low level or substantially zero level, therefore, the transfer loss, for example, at 1.38 μm frequently band can be significantly reduced.

As an example, the optical fiber preform for the silica-base glass single mode optical fiber (SMF) is described above, but the present invention is not limited to the sintering of the optical fiber preform for only the SMF. Namely, the present invention can be applied to a variety of optical fiber preform having a porous soot body to be sintered, used for a dispersion compensation optical fiber having a multiple layered structure used for, for example, a wavelength division transmission or other optical fiber.

According to the present invention, a sintering for a large-sized optical fiber preform can be performed without the occurrence of large differences of diameter in a longitudinal direction. As a result, a less or small non-circularity of optical fiber can be achieved.

According to the present invention, the consumption of the supply gas can be reduced. As a result, a cost of producing an optical fiber preform can be reduced, and therefore, a cost of producing an optical fiber can also be reduced.

For carrying out the sintering process, a new sintering apparatus is not needed, only the content of a control means is changed, and therefore, a cost on the sintering apparatus is not raised.

What is claimed is:

1. A method of producing an optical fiber preform including the step of dehydrating and sintering a porous soot body of the optical fiber preform in a state where the optical fiber preform is suspended,
the sintering being carried out by varying at least one of a sintering temperature of the porous soot body, a relative moving speed between a sintering position of the porous soot body and a sintering zone, and a flow of gas supplied to the sintering zone, in response to a position of the optical fiber preform positioned to the sintering zone.

2. A method as set forth in claim 1, wherein the dehydrating process and the sintering process are simultaneously performed in a same sintering apparatus.

3. A method as set forth in claim 1, wherein the dehydrating process is performed, and the sintering process is performed.

4. A method as set forth in claim 1, wherein the sintering temperature of the porous soot body is controlled in response to the position of the optical fiber preform positioned to the sintering zone under the following condition, when a predetermined flow of the gas is supplied to the sintering zone and at a predetermined relative speed between the optical fiber preform and the sintering zone,
T₁>T₂>T₃
where,
T₁ is a sintering temperature of the porous soot body at a lower end of the optical fiber preform,
T₃ is a sintering temperature of the porous soot body at an upper end of the optical fiber preform, and
T₂ is a sintering temperature of the porous soot body at an intermediate portion between the lower and upper ends, and is changed monotonously from the temperature T₁ to the temperature T₃.

5. A method as set forth in claim 1, wherein the relative moving speed between the sintering zone and the optical fiber preform is controlled in response to the position of the optical fiber preform positioned to the sintering zone under the following condition, when a predetermined flow of the gas is supplied to the sintering zone, at a predetermined sintering temperature,
S₁<S₂<S₃
where,
S₁ is the relative moving speed when sintering the porous soot body at a lower end of the optical fiber preform,
S₃ is the relative speed when sintering the porous soot body at an upper end of the optical fiber preform, and
S₂ is the relative speed when sintering the porous soot body at an intermediate portion between the lower and upper ends, and is changed monotonously from the speed S₁ to the speed S₃.

6. A method as set forth in claim 1, wherein the flow of the gas supplied to the sintering zone is controlled in response to the position of the optical fiber preform positioned to the sintering zone under the following condition, at a predetermined relative speed between the optical fiber preform and the sintering zone,
V₁>V₂>V₃
where,
V₁ is the flow of the gas when sintering the porous soot body at a lower end of the optical fiber preform,
V₃ is the flow of the gas when sintering the porous soot body at an upper end of the optical fiber preform, and
V₂ is the flow of the gas when sintering the porous soot body at an intermediate portion between the lower and upper ends, and is between the flow V₁ and the flow V₃.

7. An apparatus for dehydrating and sintering a porous soot body of an optical fiber preform, comprising:
a furnace tube into which the optical fiber preform is introduced;
a supporting means for holding an end the optical fiber preform, being rotatable the optical fiber preform and introducing the optical fiber preform into the furnace tube;
a heating means for heating the optical fiber preform introduced into the furnace tube;
a position sensing means for detecting a relative position between a sintering position of the porous soot body and a sintering zone in the furnace tube;
a speed sensing means for detecting a relative moving speed between the sintering zone in the furnace tube and the optical fiber preform;
a gas supplying means for supplying a sintering gas to the sintering zone in the furnace tube;
a temperature sensing means for detecting a sintering temperature at the sintering zone in the furnace tube; and
a control means,
the control means controlling the sintering by varying at least one of a sintering temperature of the porous soot body, a relative moving speed between a sintering position of the porous soot body and a sintering zone, and a flow of gas supplied to the sintering zone, in response to a position of the optical fiber preform positioned at the sintering zone.

8. An apparatus as set forth in claim 7, wherein the control means controls the heating means to control the sintering temperature of the porous soot body in response to the position signal detected by the position sensing means under the following condition, when a predetermined flow of the gas is supplied to the sintering zone, at a predetermined relative speed between the optical fiber preform and the sintering zone,
T₁>T₂>T₃
where,
T₁ is a sintering temperature of the porous soot body at a lower end of the optical fiber preform,
T₃ is a sintering temperature of the porous soot body at an upper end of the optical fiber preform, and
T₂ is a sintering temperature of the porous soot body at an intermediate portion between the lower and upper ends, and is changed monotonously from the temperature T₁ to the temperature T₃.

9. A An apparatus as set forth in claim 7, wherein the control means controls the supporting means to control the relative moving speed of the sintering zone and the optical fiber preform, in response to the position signal detected by the position sensing means under the following condition, when a predetermined flow of the gas is supplied to the sintering zone, at a predetermined sintering temperature,
S₁<S₂>S₃
where,
S₁ is the relative moving speed when sintering the porous soot body at a lower end of the optical fiber preform,
S₃ is the relative speed when sintering the porous soot body at an upper end of the optical fiber preform, and
S₂ is the relative speed when sintering the porous soot body at an intermediate portion between the lower and upper ends, and is changed monotonously from the speed S₁ to the speed S₃.

10. An apparatus as set forth in claim 7, wherein the control means controls the gas supplying means to control the flow of the gas supplied to the sintering zone in response to the position signal detected by the position sensing means under the following condition, at a predetermined relative speed between the optical fiber preform and the sintering zone,
V₁>v₂>v₃
where,
V₁ is the flow of the gas when sintering the porous soot body at a lower end of the optical fiber preform,
V₃ is the flow of the gas when sintering the porous soot body at an upper end of the optical fiber preform, and
V₂ is the flow of the gas when sintering the porous soot body at an intermediate portion between the lower and upper ends, and is between the flow V₁ and the flow V₃.

11. An apparatus for sintering a dehydrated porous soot body of an optical fiber preform, comprising:
a furnace tube into which the optical fiber preform is introduced;
a supporting means for holding an end the optical fiber preform, being rotatable the optical fiber preform and introducing the optical fiber preform into the furnace tube;
a heating means for heating the optical fiber preform introduced into the furnace tube;
a position sensing means for detecting a relative position between a sintering position of the porous soot body and a sintering zone in the furnace tube;
a speed sensing means for detecting a relative moving speed between the sintering zone in the furnace tube and the optical fiber preform;
a gas supplying means for supplying a sintering gas to the sintering zone in the furnace tube;
a temperature sensing means for detecting a sintering temperature at the sintering zone in the furnace tube; and
a control means,
the control means controlling the sintering by varying at least one of a sintering temperature of the porous soot body, a relative moving speed between a sintering position of the porous soot body and a sintering zone, and a flow of the gas supplied to the sintering zone, in response to a position of the optical fiber preform positioned at the sintering zone.

12. An apparatus as set forth in claim 11, wherein the control means controls the heating means to control the sintering temperature of the porous soot body in response to the position signal detected by the position sensing means under the following condition, when a predetermined flow of the gas is supplied to the sintering zone, and at a predetermined relative speed between the optical fiber preform and the sintering zone,
T₁>T₂≧T₃
where,
T₁ is a sintering temperature of the porous soot body at a lower end of the optical fiber preform,
T₃ is a sintering temperature of the porous soot body at an upper end of the optical fiber preform, and
T₂ is a sintering temperature of the porous soot body at an intermediate portion between the lower and upper ends, and is changed monotonously from the temperature T₁ to the temperature T₃.

13. An apparatus as set forth in claim 11, wherein the control means controls the supporting means to control the relative moving speed of the sintering zone and the optical fiber preform, in response to the position signal detected by the position sensing means under the following condition, when a predetermined flow of the gas is supplied to the sintering zone, at a predetermined sintering temperature,
S₁<S₂≦S₃
where,
S₁ is the relative moving speed when sintering the porous soot body at a lower end of the optical fiber preform,
S₃ is the relative speed when sintering the porous soot body at an upper end of the optical fiber preform, and
S₂ is the relative speed when sintering the porous soot body at an intermediate portion between the lower and upper ends, and is changed monotonously from the speed S₁ to the speed S₃.

14. An apparatus as set forth in claim 11, wherein the control means controls the gas supplying means to control the flow of the gas supplied to the sintering zone in response to the position detected by the position sensing means under the following condition, at a predetermined relative speed between the optical fiber preform and the sintering zone,
V₁>V₂>V₃
where,
V₁ is the flow of the gas when sintering the porous soot body at a lower end of the optical fiber preform,
V₃ is the flow of the gas when sintering the porous soot body at an upper end of the optical fiber preform, and
V₂ is the flow of the gas when sintering the porous soot body at an intermediate portion between the lower and upper ends, and is between the flow V₁ and the flow V₃.
